(19) United States
(12) Patent Application Publication
(10) Pub. No.: US 2023/0274748 A1
(43) Pub. Date: Aug. 31, 2023

(54) CODING OF MULTI-CHANNEL AUDIO SIGNALS

(71) Applicant: Telefonaktiebolaget LM Ericsson (publ), Stockholm (SE)

(72) Inventors: Harald POBLOTH, Täby (SE); Stefan BRUHN, Sollentuna (SE)

(73) Assignee: Telefonaktiebolaget LM Ericsson (publ), Stockholm (SE)

(21) Appl. No.: 18/110,406

(22) Filed: Feb. 16, 2023

Related U.S. Application Data
(63) Continuation of application No. 15/573,866, filed on Nov. 14, 2017, now abandoned.
(60) Provisional application No. 62/164,141, filed on May 20, 2015.

(51) Int. Cl. G10L 19/008; G10L 19/22

(52) U.S. Cl. CPC G10L 19/008; G10L 19/22

(57) ABSTRACT

A method for assisting a selection of an encoding mode for a multi-channel audio signal encoding where different encoding modes may be chosen for the different channels. The method is performed in an audio encoder and comprises obtaining a plurality of audio signal channels and coordinating or synchronizing the selection of an encoding mode for a plurality of the obtained channels, wherein the coordination is based on an encoding mode selected for one of the obtained channels or for a group of the obtained channels.

### CROSS-REFERENCE TO RELATED APPLICATIONS

This application is a continuation of U.S. application Ser. No. 15/573,866, filed on Nov. 14, 2017 (status pending), which is the 35 U.S.C. § 371 National Stage of International Patent Application No. PCT/EP2016/061245, filed May 19, 2016, which claims priority to U.S. provisional application No. 62/164,141, filed on May 20, 2015. The above identified applications are incorporated by this reference.

### TECHNICAL FIELD

The disclosed subject matter relates to audio coding and more particularly to coding of stereo or multi-channel signals with two or more instances of a codec that comprises several codec modes.

### BACKGROUND

Cellular communication networks evolve towards higher data rates, improved capacity and improved coverage. In the 3rd Generation Partnership Project (3GPP) standardization body, several technologies have been and are also currently being developed.

LTE (Long Term Evolution) is an example of a standardised technology. In LTE, an access technology based on OFDM (Orthogonal Frequency Division Multiplexing) is used for the downlink, and Single Carrier FDMA (SC-FDMA) for the uplink. The resource allocation to wireless terminals, also known as user equipment, UEs, on both downlink and uplink is generally performed adaptively using fast scheduling, taking into account the instantaneous traffic pattern and radio propagation characteristics of each wireless terminal. One type of data over LTE is audio data, e.g. for a voice conversation or streaming audio.

To improve the performance of low bitrate speech and audio coding, it is known to exploit a-priori knowledge about the signal characteristics and employ signal modelling. With more complex signals, several coding models, or coding modes, may be used for different signal types and different parts of the signal. It is beneficial to select the appropriate coding mode at any one time.

In systems where a stereo or multi-channel signal is to be transmitted but the available or preferred codec does not include a dedicated stereo mode, it is possible to encode and transmit each channel of the signal with a separate instance of the codec at hand. This means that if e.g. there are two channels in the stereo case that the codec is run once for the left channel and once for the right channel. Separate instances means that there is no coupling of the left and right channel encodings. The encoding with “different instances” may be parallel, e.g. be preformed simultaneously in a preferred case, but may alternatively be serial. For the stereo case, both the left/right representation and the mid-/side-representation may be considered as two channels of a stereo signal. Similarly, for the multi-channel case, the channels can be represented for coding in a different way as they are rendered or as they are captured. When time aligning the decoded signals at the receiver, those can be used to render or reconstruct the stereo or multi-channel signal. For the stereo case this is often called dual-mono coding.

In a typical situation, each microphone may represent one channel that is encoded and that after decoding is played out by one loudspeaker. However, it is also possible to generate virtual input channels based on different combinations of the microphone signals. In the stereo case for instance, often mid/side representation is chosen instead of left/right representation. In the most simple case the mid signal is generated by adding left and right channel signals while the side signal is obtained by taking the difference. Conversely, at the decoder, there can again be a similar remapping, e.g. from mid/side representation to left/right. The left signal (except e.g. for a constant scaling factor) may be obtained by adding mid and side signals, the right signal may be obtained by subtracting these signals. In general there may be a corresponding mapping of N microphone signals to M virtual input channels that are coded and from M virtual output channels received from a decoder to K loudspeakers. These mappings may be obtained by linear combination of the respective input signals of the mapping, which can mathematically be formulated by a multiplication of the input signals with a mapping matrix.

Many recently developed codecs comprise a plurality of different coding modes that may be selected e.g. based on the characteristics of the signal which is to be encoded/decoded. To select the best encoding/decoding mode, an encoder and/or decoder may try all available modes in an analysis-by-synthesis, also called a closed loop fashion, or it may rely on a signal classifier which makes a decision on the coding mode based on a signal analysis, also called an open loop decision. An example of codecs comprising different selectable coding modes may be codecs that contain both ACELP (speech) encoding strategies, or modes, and MDCT (music) encoding strategies, or modes. Further important examples of main coding modes are active signal coding versus discontinuous transmission (DTX) schemes with comfort noise generation. For that case typically a voice activity detector or a signal activity detector is used to select one of these coding modes. Further coding modes may be chosen in response to a detected audio bandwidth. If for instance, in the input audio bandwidth is only narrowband (no signal energy above 4 khz), then a narrowband coding mode could be chosen, as compared to if the signal is e.g. wideband (signal energy up to 8 kHz), super-wideband (signal energy up to 16 khz) or fullband (energy on the full audible spectrum). A further example of different coding modes is related to bit rate used for encoding. A rate selector may select different bit rates for encoding based on either the audio input signal or requirements of the transmission network.

Often, the main coding strategies, in their turn, comprise a plurality of sub-strategies that also may be selected e.g. based on a signal classifier. Examples of such sub-strategies could be (when the main strategies are MDCT coding and ACELP coding) e.g. MDCT coding of noise-like signals and MDCT coding of harmonic signals, and/or different ACELP excitation representations.

Regarding audio signal classification, typical signal classes for speech signals are voiced and unvoiced speech utterances. For general audio signals, it is common to discriminate between speech, music and potentially background noise signals.

### SUMMARY

According to a first aspect there is provided a method for assisting a selection of an encoding mode for a multi-channel audio signal encoding where different encoding modes may be chosen for the different channels. The method is performed in an audio encoder and comprises obtaining a plurality of audio signal channels and coordinating or synchronizing the selection of an encoding mode for a plurality of the obtained channels, wherein the coordination is based on an encoding mode selected for one of the obtained channels or for a group of the obtained channels.

According to a second aspect there is provided an apparatus for assisting a selection of an encoding mode for a multi-channel audio signal. The apparatus comprises a processor and a memory for storing instructions that, when executed by the processor, causes the apparatus to obtain a plurality of audio signal channels and to coordinate or synchronize the selection of an encoding mode for a plurality of the obtained channels, wherein the coordination is based on an encoding mode selected for one of the obtained channels or for a group of the obtained channels.

According to a third aspect there is provided a computer program for assisting a selection of an encoding mode for audio. The computer program comprises computer program code which, when run on an apparatus causes the apparatus to obtain a plurality of audio signal channels and to coordinate or synchronize the selection of an encoding mode for a plurality of the obtained channels, wherein the coordination is based on an encoding mode selected for one of the obtained channels or for a group of the obtained channels.

### BRIEF DESCRIPTION OF THE DRAWINGS

The drawings illustrate selected embodiments of the disclosed subject matter. In the drawings, like reference labels denote like features.

FIG. 1 is a diagram illustrating a cellular network where embodiments presented herein may be applied.

FIG. 2 is a graph illustrating a prior art solution with separate codecs for each channel without mode synchronization.

FIG. 3 is a graph illustrating an example mode decision structure inside one instance of an encoder according to the prior art.

FIG. 4 shows a solution using an external mode decision unit controlling all encoder instances according to an embodiment.

FIG. 5 illustrates an embodiment where one codec is selected as master, i.e., this codec's mode decision is imposed on all other encoders.

FIGS. 6 and 7 are flowcharts illustrating methods according to embodiments.

FIGS. 8a-c are schematic block diagrams illustrating different implementations of an encoder according to embodiments.

FIG. 9 is a diagram showing some components of a wireless terminal.

FIG. 10 is a diagram showing some components of a transcoding node.

### DETAILED DESCRIPTION

The disclosed subject matter is described below with reference to various embodiments. These embodiments are presented as teaching examples and are not to be construed as limiting of the disclosed subject matter.

When using codecs with a plurality of coding strategies, or modes, separately on two channels of a stereo signal or separately on different channels of a multi-channel signal, different codec modes may be chosen for the different channels. This is due to that the mode decisions of the different instances of the codec are independent. One example scenario where different coding modes could be selected for different channel of a signal is e.g. a stereo signal captured by an AB microphone, where one channel is dominated by a talker while the other channel is dominated by background music. In such a situation, a codec that includes, for example, both ACELP and MDCT coding modes is likely to choose an ACELP mode for the one channel dominated by speech and an MDCT mode for the other dominated by music. The signature or characteristics of the coding distortion resulting from the two coding strategies can be fairly different. In one case for instance the signature of the coding distortion may be noise like while another signature caused by a different coding mode may be pre-echo distortions sometimes observed for MDCT coding modes. Rendering signals with such different distortion signatures can lead to unmasking effects, i.e. that distortion that is reasonably well masked when only one signal is presented to a listener becomes obvious or annoying when the two signals, with their different distortion characteristics, are presented simultaneously to a listener, e.g., to the left and the right ear respectively.

According to an embodiment of the proposed solution, the mode decisions of the different instances of a codec used to encode a stereo or multi-channel signal are coordinated. Coordination may typically mean that the mode decisions are synchronized but may also mean that such modes (even though different) are selected such that coding distortion and unmasking effects are minimized. The selection of a codec mode, and potentially of a codec sub-mode, for encoding of the different channels of a multi channel signal in different instances of a codec may be synchronized e.g. such that the same codec mode is selected for all channels, or at least such that a related codec mode, having similar distortion characteristics, is selected by the codec instances for all channels of the multi-channel signal. By synchronizing or coordinating the selection of codec mode for the different channels of a multi-channel signal, the signature or characteristics of the coding artifacts will be similar for all channels. Thus, when reconstructing the multi channel signal and playing out them there will be no unmasking effects or at least reduced unmasking. Embodiments of the solution may include a decision algorithm that determines or measures whether a synchronization of mode decisions is necessary or not. For example, such an algorithm may give a prediction of whether un-masking effects, as described above, can or will appear for the different channels of the multi-channel signal at hand. In case of applying such an algorithm, the synchronisation or coordination of mode decisions in different instances of a codec may be activated selectively, e.g. only when the decision algorithm judges or indicates this to be necessary and/or advantageous.

By applying an embodiment related to synchronized or coordinated mode decision described herein, deviating coding distortion signatures in different channels of a stereo or multi-channel signal may be avoided or at least mitigated. This will improve the sound quality and spatial representation of the signal, which is advantageous. In addition, embodiments of the solution enables saving of computational complexity e.g. when only one mode decision needs to be taken for all instances of the codec.

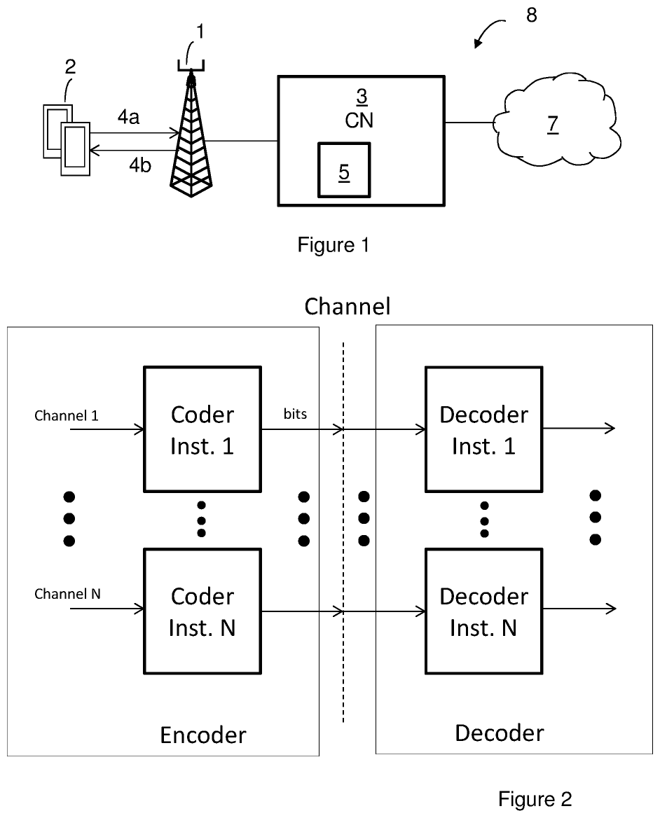

An exemplifying network context is illustrated in FIG. 1, which is a diagram illustrating a wireless network 8 where embodiments presented herein may be applied. The wireless network 8 comprises a core network 3 and one or more radio access nodes 1, here in the form of evolved Node Bs, also known as eNodeBs or eNBs. The radio base station 1 could also be in the form of Node Bs, BTSs (Base Transceiver Stations) and/or BSSs (Base Station Subsystems), etc. The radio base station 1 provides radio connectivity to a plurality of wireless devices 2. The term wireless device is also known as wireless communication device or radio communication device such as a UE, which is also known as e.g., mobile terminal, wireless terminal, mobile station, mobile telephone, cellular telephone, smart phone, and/or target device. Further examples of different wireless devices include laptops with wireless capability, Laptop Embedded Equipment (LEE), Laptop Mounted Equipment (LME), USB dongles, Customer Premises Equipment (CPE), modems, Personal Digital Assistants (PDA), or tablet computers, sometimes referred to as a surf plates with wireless capability or simply, tablets, Machine-to-Machine (M2M) capable devices or UEs, device to device (D2D) UE or wireless devices, devices equipped with a wireless interface, such as a printer or a file storage device, Machine Type Communication (MTC) devices such as sensors, e.g., a sensor equipped with UE, just to mention some examples.

The wireless network 8 may e.g. comply with any one or a combination of LTE (Long Term Evolution), W-CDMA (Wideband Code Division Multiplex), EDGE (Enhanced Data Rates for GSM (Global System for Mobile communication) Evolution), GPRS (General Packet Radio Service), CDMA2000 (Code Division Multiple Access 2000), or any other current or future wireless network, such as LTE-Advanced, as long as the principles described hereinafter are applicable.

Uplink (UL) 4a communication from the wireless terminal 2 and downlink (DL) 4b communication to the wireless terminal 2 between the wireless terminal 2 and the radio base station 1 is performed over a wireless radio interface. The quality of the wireless radio interface to each wireless terminal 2 can vary over time and depending on the position of the wireless terminal 2, due to effects such as fading, multipath propagation, interference, etc.

The radio base station 1 is also connected to the core network 3 for connectivity to central functions and an external network 7, such as the Public Switched Telephone Network (PSTN) and/or the Internet.

Audio data, such as multi-channel signals, can be encoded and decoded e.g. by the wireless terminal 2 and a transcoding node 5, being a network node arranged to perform transcoding of audio. The transcoding node 5 can e.g. be implemented in a MGW (Media Gateway), SBG (Session Border Gateway)/BGF (Border Gateway Function) or MRFP (Media Resource Function Processor). Hence, both the wireless terminal 2 and the transcoding node 5 are host devices, which comprise a respective audio encoder and decoder. Obviously, the solution disclosed herein may be applied in any device or node where it is desired to encode multi-channel audio signals.

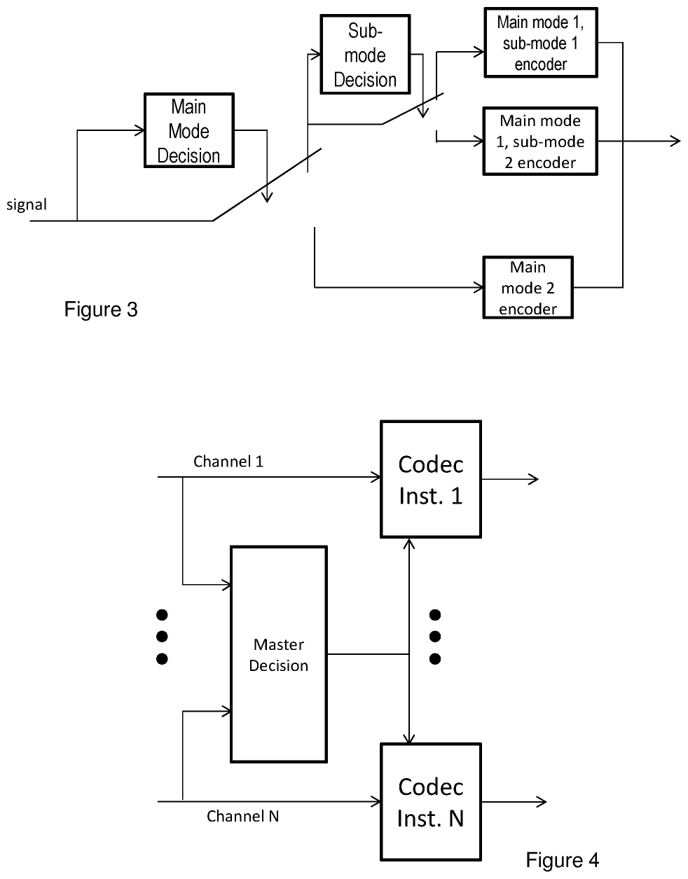

The solution described herein concerns, at least, a system where a multi-channel or stereo signal is encoded with one instance of the same codec per channel, and where each of the instances selects from a plurality of different operation modes related e.g. to MDCT and ACELP coding. FIGS. 2 and 3 depict an example of such a system, where it would be beneficial to apply embodiments of the solution. FIG. 2 depicts the prior art situation where each of the input audio channels is encoded separately by one instance of the codec. FIG. 3 shows an example of an instance of a codec with a multitude of selectable coding modes, including main modes and sub-modes. The different modes may be selected dependent on signal characteristics and different mode decision algorithms may be assumed in place to select the correct mode.

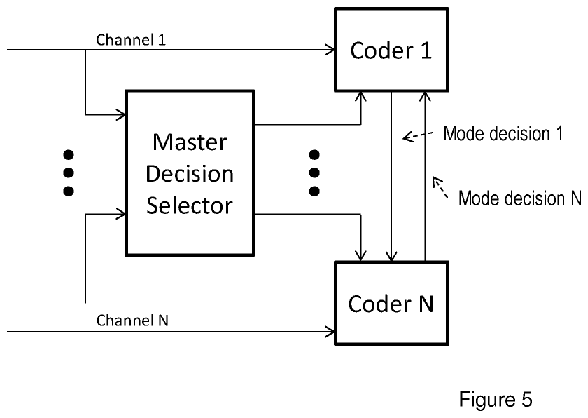

FIGS. 4 and 5 depict embodiments of the proposed solution. In FIG. 4, an external (i.e. external to the instances) mode decision algorithm controls the mode selection of all codec instances. In another embodiment or scenario, the external mode decision algorithm can detect or identify a set of channels that should be synchronized/coordinated. One example where this can be meaningful is when there are groups of channels dominated by different source signals. It is also possible to perform only a subset of mode-decisions in the external mode decision unit and to locally decide on some of the sub-modes. For example, in a codec or arrangement comprising a number of entities similar to the one illustrated in FIG. 3, the main mode decision can be synchronized/coordinated while the sub-mode decisions can be performed locally. In FIG. 5 the mode decision algorithm (internal) from one of the codec instances is used to control all codec instances, and an external unit selects the master codec instance, i.e., the codec instance that should impose its mode decision on the other codec instances.

Input to the decision blocks of FIGS. 3 to 5 are all channel signals or a subset thereof. The decision may involve identifying one or several dominant channels, e.g. based on signal energy, or other more sophisticated criteria such as perceptual complexity of the signal or perceptual entropy that may be a measure how demanding the encoding will be. The decision may also be based on certain combinations of the input channel signals. One possibility is that certain channels are used to compensate signal components in other channels (for instance compensating a background noise floor) and that such channels after said compensation would be used for the decision.

With regards to the embodiment according to FIG. 4 where the master decision is external of the codec instances it is important to include as one special embodiment even the case where only a single instance of a codec is used, which allows for encoding of a single (mono) channel signal only. In that particular embodiment supplementary stereo or multi-channel coding information may be generated and conveyed by a separate stereo or multi-channel codec instance, which for instance may be the case when the stereo or multi-channel coding is parametric. In this embodiment it is then important that the mode decision of the single mono codec may be superseded/controlled by the external mode decision block.

According to at least some embodiments of the solution, codec or encoder mode decisions of one encoder instance are applied to, or imposed on, other encoder instances in a situation where a number of instances of the same codec, e.g. parallel, are used to encode stereo or other multi-channel signals

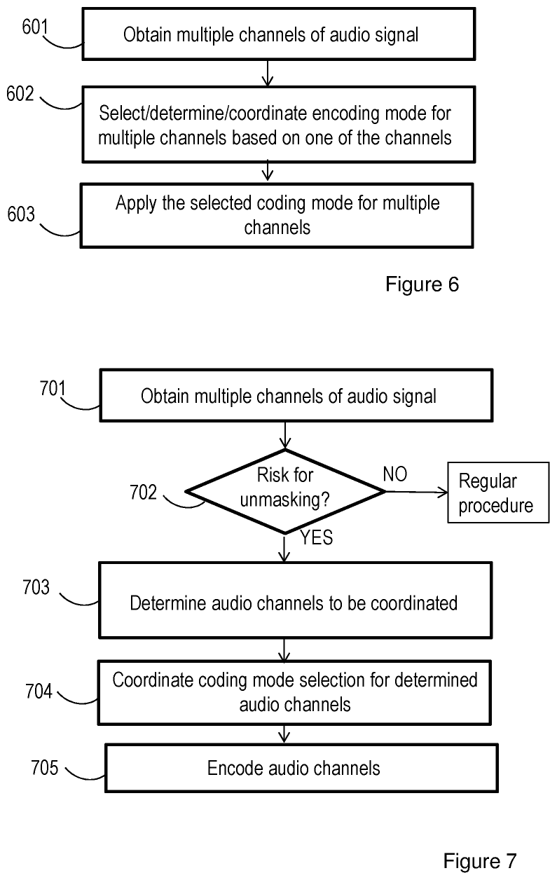

### Further Embodiments FIGS. 6-7

Below, embodiments related to a method e.g. for supporting encoding a multi-channel audio signal, e.g. a stereo signal, will be described with reference to FIG. 6. The method is to be performed e.g. by a codec or an encoder comprising multiple instances and comprising a plurality of different selectable coding modes, such as ACELP and MDCT coding, within each instance. Alternatively, it could be a codec arrangement comprising multiple codecs or encoders each comprising a plurality of selectable coding modes. The encoder or codec may be configured for being compliant with one or more standards for audio coding. The method illustrated in FIG. 6 comprises obtaining 601 multiple channels of an audio signal. The obtaining could comprise e.g. receiving the audio signal channels from a microphone or from some other entity, or retrieving them from a storage. The audio signal could be a stereo signal or comprise more than two channels. By multi-channel audio signal is herein generally meant an audio signal comprising more than one channel, i.e. at least two channels. The different obtained channels are provided to separate instances of the encoder (or separate encoders, depending on terminology and/or implementation). The method further comprises selecting 602 an encoding mode based on one or a multitude of the channels, where the selected encoding mode is to be used for encoding at least a plurality of the multiple obtained channels, i.e. not only for the one channel based on which it is selected. The method further comprises applying 603 the selected coding mode for a plurality of the obtained channels, e.g. all or a sub-set of the channels. This may alternatively be described as, and/or implemented as, that the method comprises imposing an encoding mode selected for one of the multiple channels on the encoding of multiple of the obtained channels. Alternatively, it could be described as controlling the encoding mode selection of multiple encoder instances based on an encoding mode selected for one of the obtained channels by one of the encoder instances. An embodiment could alternatively be described as encoding multiple channels of a multi-channel audio signal based on an encoding mode selection made based on (or for) one of the channels.

A more elaborated method embodiment will now be described with reference to FIG. 7. The method illustrated in FIG. 7 comprises obtaining multiple channels of an audio signal. The channels are, as before to be provided to a respective encoder instance for encoding. The method further comprises determining 702 whether there is a risk for unmasking effects or other unwanted effects for the obtained multiple channels, e.g. due to selection of different encoding modes for different channels, as previously described. The action 702 could alternatively be described as determining whether there is a need for coordinating the encoding mode selection of the multiple instances encoding the multiple channels. This determining could involve e.g. determining whether the different channels belong to or are dominated by different audio signal types, such as music or speech, where the different types would typically result in selection of different encoding modes. If there is no risk or probability for unwanted effects or artifacts e.g. due to diverging encoding mode selection, there is no need for a coordination of the encoding mode selection for the different entities, and the encoding procedure may proceed according to regular procedure. However, if it is determined e.g. in an action 702 that there is a need for coordinating the encoding mode selection for the different audio signal channels, such coordination should be done. The method may further comprise an optional action of determining 703 which of the channels that actually need to be coordinated in regard of encoding mode selection. This action could involve classifying the channels into different groups based on whether they belong to or are dominated by different audio signal types, such as music or speech. The coding mode selection for encoding of channels classified into a first group could then be controlled or coordinated 704 such that the encoding mode selected for the channels in a second group is used also for the first group. There could be more than two groups of signals. The audio signal channels may then be encoded 705 using the coordinated encoding mode selected for one of the channels or a group of the channels.

### Exemplifying Implementations

The method and techniques described above may be implemented in encoders and/or decoders, which may be part of e.g. communication devices or other host devices.

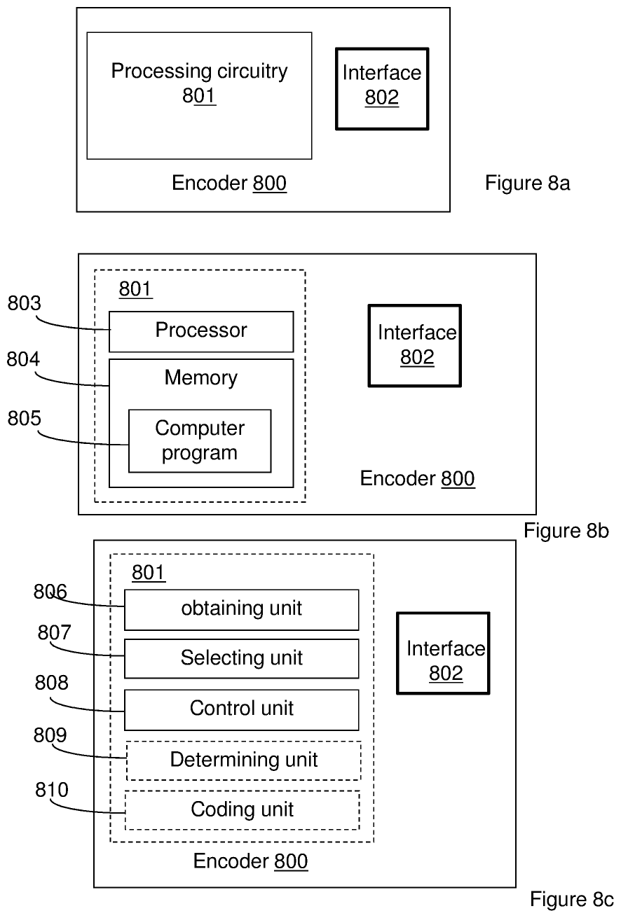

Encoder or Codec, FIGS. 8a-8c

An encoder is illustrated in a general manner in FIG. 8a. The encoder is configured to encode audio signals, which supports encoding (e.g. parallel encoding by a plurality of instances of an encoder) of a plurality of signals, such as a number of channels of a multi-channel audio signal. The encoder may further comprise a plurality of different selectable encoding modes, such as e.g. ACELP and MDCT coding and sub-modes thereof, as previously described. The encoder may be further be configured for encoding other types of signals. Encoder 800 is configured to perform at least one of the method embodiments described above with reference e.g. to any of FIGS. 4-7. Encoder 800 is associated with the same technical features, objects and advantages as the previously described method embodiments. The decoder may be configured for being compliant with one or more standards for audio coding/decoding. The encoder will be described in brief in order to avoid unnecessary repetition.

The encoder may be implemented and/or described as follows:

Encoder 800 is configured for encoding an audio signal comprising a plurality of channels. Encoder 800 comprises processing circuitry, or a processing component 801 and a communication interface 802. Processing circuitry 801 may be configured e.g. to cause encoder 800 to obtain multiple channels of an audio signal, and further to coordinate or synchronize the selection of an encoding mode. Processing circuitry 801 may further be configured to cause the encoder to apply the coordinated encoding mode for encoding of all, or at least a plurality of the obtained plurality of channels. The communication interface 802, which may also be denoted e.g. Input/Output (I/O) interface, includes an interface for sending data to and receiving data from other entities or modules.

Processing circuitry 801 could, as illustrated in FIG. 8b, comprise one or more processing components, such as a processor 803, e.g. a CPU, and a memory 804 for storing or holding instructions. The memory would then comprise instructions, e.g. in form of a computer program 805, which when executed by processor 803 causes encoder 800 to perform the actions described above.

An alternative implementation of processing circuitry 801 is shown in FIG. 8c. The processing circuitry may here comprise an obtaining unit 806, configured to cause encoder 800 to obtain a plurality of audio signal channels. The processing circuitry may further comprise a selecting unit 807, configured to cause the encoder to select an encoding mode out of a plurality of encoding modes based on one of the audio signal channels. The processing circuitry may further comprise an applying unit or control unit 808, configured to cause the encoder to apply the selected encoding mode for at least a plurality of the channels. Processing circuitry 801 could comprise more units, such as a determining unit 809 configured to cause the encoder to determine whether coordination of encoding mode selection is needed for the audio signal channels in question. The processing circuitry may further comprise a coding unit 810, configured to cause the encoder to actually encode the channels using the coordinated encoding mode. These latter units are illustrated with a dashed outline in FIG. 8c in order to emphasize that they are even more optional than the other units. The units may be combined according to need or preference to achieve an adequate implementation.

The encoders, or codecs, described above could be configured for the different method embodiments described herein.

Encoder 800 may be assumed to comprise further functionality when needed, for carrying out regular encoder functions.

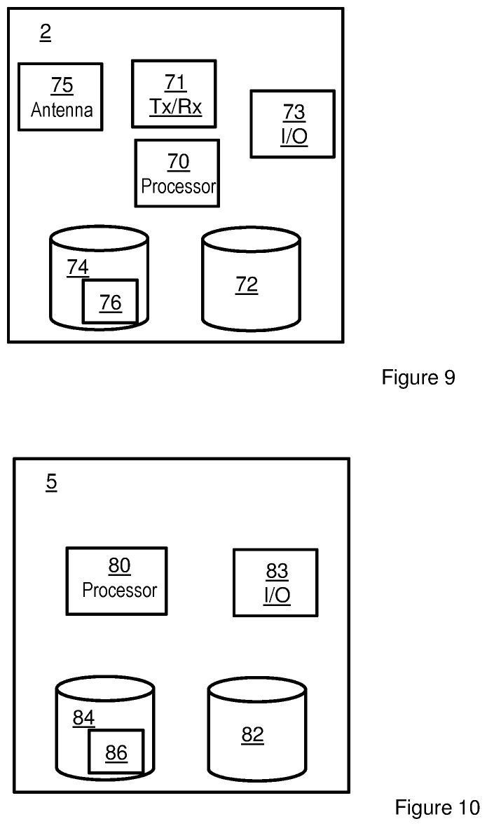

FIG. 9 is a diagram showing some components of a wireless terminal 2 of FIG. 1. A processor 70 is provided using any combination of one or more of a suitable central processing unit (CPU), multiprocessor, microcontroller, digital signal processor (DSP), application specific integrated circuit etc., capable of executing software instructions 76 stored in a memory 74, which can thus be a computer program product. The processor 70 can execute the software instructions 76 to perform any one or more embodiments of the methods described with reference to FIGS. 4-7 above.

The memory 74 can be any combination of read and write memory (RAM) and read only memory (ROM). The memory 74 also comprises persistent storage, which, for example, can be any single one or combination of magnetic memory, optical memory, solid state memory or even remotely mounted memory.

A data memory 72 is also provided for reading and/or storing data during execution of software instructions in the processor 70. The data memory 72 can be any combination of read and write memory (RAM) and read only memory (ROM).

The wireless terminal 2 further comprises an I/O interface 73 for communicating with other external entities. The I/O interface 73 also includes a user interface comprising a microphone, speaker, display, etc. Optionally, an external microphone and/or speaker/headphone can be connected to the wireless terminal.

The wireless terminal 2 also comprises one or more transceivers 71, comprising analogue and digital components, and a suitable number of antennas 75 for wireless communication with wireless terminals as shown in FIG. 1.

The wireless terminal 2 comprises an audio encoder and an audio decoder. These may be implemented in the software instructions 76 executable by the processor 70 or using separate hardware (not shown).

Other components of the wireless terminal 2 are omitted in order not to obscure the concepts presented herein.

FIG. 10 is a diagram showing some components of the transcoding node 5 of FIG. 1. A processor 80 is provided using any combination of one or more of a suitable central processing unit (CPU), multiprocessor, microcontroller, digital signal processor (DSP), application specific integrated circuit etc., capable of executing software instructions 86 stored in a memory 84, which can thus be a computer program product. The processor 80 can be configured to execute the software instructions 86 to perform any one or more embodiments of the methods described with reference to FIGS. 4-7 above.

The memory 84 can be any combination of read and write memory (RAM) and read only memory (ROM). The memory 84 also comprises persistent storage, which, for example, can be any single one or combination of magnetic memory, optical memory, solid state memory or even remotely mounted memory.

A data memory 82 is also provided for reading and/or storing data during execution of software instructions in the processor 80. The data memory 82 can be any combination of read and write memory (RAM) and read only memory (ROM).

The transcoding node 5 further comprises an I/O interface 83 for communicating with other external entities such as the wireless terminal of FIG. 1, via the radio base station 1.

The transcoding node 5 comprises an audio encoder and an audio decoder. These may be implemented in the software instructions 86 executable by the processor 80 or using separate hardware (not shown).

Other components of the transcoding node 5 are omitted in order not to obscure the concepts presented herein.

The solution described herein also relates to a computer program product comprising a computer readable medium. On this computer readable medium a computer program can be stored, which computer program can cause a processor to execute a method according to embodiments described herein. The computer program product may be an optical disc, such as a CD (compact disc) or a DVD (digital versatile disc) or a Blu-Ray disc. As explained above, the computer program product could also be embodied in a memory of a device, such as the computer program product 804 of FIG. 8b. The computer program can be stored in any way which is suitable for the computer program product. The computer program product may be a removable solid state memory, e.g. a Universal Serial Bus (USB) stick.

The solution described herein further relates to a carrier containing a computer program, which when executed on at least one processor, cause the at least one processor to carry out the method according e.g. to an embodiment described herein. The carrier may be e.g. one of an electronic signal, an optical signal, a radio signal, or computer readable storage medium.

The following are certain enumerated embodiments further illustrating various aspects the disclosed subject matter.

1. A method for assisting a selection of an encoding mode for audio, the method being performed in an audio encoder and comprising: obtaining a plurality of audio signal channels; and coordinating or synchronising the selection of an encoding mode for a plurality of the obtained channels, where the coordination may be based on an encoding mode selected for one of the obtained channels, or for a group of the obtained channels.

2. The method according to embodiment 1, further comprising applying a coding mode selected for one of the obtained channels for encoding a plurality of the obtained channels.

3. The method according to embodiment 1 or 2, further comprising determining whether coordination of the selection of encoding mode is required, and performing the coordination when it is required.

4. The method according to any one of the preceding embodiments, further comprising determining of which of the channels that need to be coordinated.

5. The method according to any one of the preceding embodiments, further comprising encoding the audio signal channels in accordance with the coordinated encoding mode selection.

6. A host device (2, 5) and/or encoder for assisting a selection of an encoding mode for audio, the host device and/or encoder comprising: a processor (70, 80); and a memory (74, 84) storing instructions (76, 86) that, when executed by the processor, causes the host device (2, 5) and/or encoder to: obtain audio signal channels; and coordinate the selection of encoding mode for the channels.

7. The host device (2, 5) and/or encoder according to embodiment 6, further comprising instructions that, when executed by the processor, causes the host device (2, 5) and/or encoder to apply a coding mode selected for one of the obtained channels for encoding a plurality of the obtained channels.

8. The host device (2, 5) and/or encoder according to embodiment 6, further comprising instructions that, when executed by the processor, causes the host device (2, 5) and/or encoder to determine whether coordination of the selection of encoding mode is required, and to perform the coordination when it is required.

9. The host device (2, 5) and/or encoder according to any one of embodiments 6 to 8, wherein the instructions to classify the audio signal comprise instructions that, when executed by the processor, causes the host device (2, 5) and/or encoder to determine which of the obtained audio channels that require coordination.

10. A computer program for assisting a selection of an encoding mode for audio, the computer program comprising computer program code which, when run on a host device (2, 5) and/or encoder causes the host device (2, 5) and/or encoder to: obtain audio signal channels; and coordinate the selection of encoding mode for the channels.

11. A computer program product comprising a computer program according to embodiment 10 and a computer readable medium on which the computer program is stored.

The steps, functions, procedures, modules, units and/or blocks described herein may be implemented in hardware using any conventional technology, such as discrete circuit or integrated circuit technology, including both general-purpose electronic circuitry and application-specific circuitry.

Particular examples include one or more suitably configured digital signal processors and other known electronic circuits, e.g. discrete logic gates interconnected to perform a specialized function, or Application Specific Integrated Circuits (ASICs).

Alternatively, at least some of the steps, functions, procedures, modules, units and/or blocks described above may be implemented in software such as a computer program for execution by suitable processing circuitry including one or more processing units. The software could be carried by a carrier, such as an electronic signal, an optical signal, a radio signal, or a computer readable storage medium before and/or during the use of the computer program in the network nodes. The network node and indexing server described above may be implemented in a so-called cloud solution, referring to that the implementation may be distributed, and the network node and indexing server therefore may be so-called virtual nodes or virtual machines.

The flow diagram or diagrams presented herein may be regarded as a computer flow diagram or diagrams, when performed by one or more processors. A corresponding apparatus may be defined as a group of function modules, where each step performed by the processor corresponds to a function module. In this case, the function modules are implemented as a computer program running on the processor.

Examples of processing circuitry includes, but is not limited to, one or more microprocessors, one or more Digital Signal Processors, DSPs, one or more Central Processing Units, CPUs, and/or any suitable programmable logic circuitry such as one or more Field Programmable Gate Arrays, FPGAs, or one or more Programmable Logic Controllers, PLCs. That is, the units or modules in the arrangements in the different nodes described above could be implemented by a combination of analog and digital circuits, and/or one or more processors configured with software and/or firmware, e.g. stored in a memory. One or more of these processors, as well as the other digital hardware, may be included in a single application-specific integrated circuitry, ASIC, or several processors and various digital hardware may be distributed among several separate components, whether individually packaged or assembled into a system-on-a-chip, SoC.

It should also be understood that it may be possible to re-use the general processing capabilities of any conventional device or unit in which the proposed technology is implemented. It may also be possible to re-use existing software, e.g. by reprogramming of the existing software or by adding new software components.

The embodiments described above are merely given as examples, and it should be understood that the proposed technology is not limited thereto. It will be understood by those skilled in the art that various modifications, combinations and changes may be made to the embodiments without departing from the present scope. In particular, different part solutions in the different embodiments can be combined in other configurations, where technically possible.

In some alternate implementations, functions/acts noted in blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of the disclosed subject matter.

It is to be understood that the choice of interacting units, as well as the naming of the units within this disclosure are only for exemplifying purpose, and nodes suitable to execute any of the methods described above may be configured in a plurality of alternative ways in order to be able to execute the suggested procedure actions.

It should also be noted that the units described in this disclosure are to be regarded as logical entities and not with necessity as separate physical entities.

While the disclosed subject matter has been presented above with reference to various embodiments, it will be understood that various changes in form and details may be made to the described embodiments without departing from the overall scope of the disclosed subject matter.

1. A method for selecting an encoding mode for use in encoding one more audio signals, the method comprising:
obtaining a primary audio signal;
obtaining a secondary audio signal;
obtaining information indicating a characteristic of the primary audio signal;
selecting an encoding mode for use in encoding the secondary audio signal based at least in part on the information indicating the characteristic of the primary audio signal; and
encoding the secondary audio signal using the selected encoding parameter.

2. The method of claim 1, further comprising:
obtaining a first audio signal; and
obtaining a second audio signal, wherein
the primary audio signal is a function of the first and second audio signals, and
the secondary audio signal is a function of the first and second audio signals.

3. The method of claim 2, wherein
obtaining the primary audio signal comprises summing the first and second audio signals, and obtaining the secondary audio signal comprises obtaining a difference between the first and second audio signals, or
obtaining the secondary audio signal comprises summing the first and second audio signals, and obtaining the primary audio signal comprises obtaining a difference between the first and second audio signals.

4. The method of claim 1, wherein
the information indicating a characteristic of the primary audio signal comprises information indicating whether or not the primary audio signal is dominated by a certain audio signal type, or
the information indicating a characteristic of the primary audio signal comprises information indicating whether a certain audio signal type is present.

5. The method of claim 4, wherein the audio signal type is music or voice.

6. The method of claim 1, further comprising:
determining that the information indicating the characteristic of the primary audio signal indicates that the primary signal is an active signal, wherein
selecting an encoding mode for use in encoding the secondary audio signal based at least in part on the information indicating the characteristic of the primary audio signal comprises selecting an active signal encoding mode for encoding the secondary audio signal as a result of determining that the information indicating the characteristic of the primary audio signal indicates that the primary signal is an active signal, and
the step of encoding the secondary audio signal using the selected active signal encoding mode is performed regardless of whether or not the secondary audio signal is also an active signal.

7. The method of claim 1, wherein selecting the encoding mode for use in encoding the secondary audio signal based at least in part on the information indicating the characteristic of the primary audio signal comprises selecting between an active signal encoding mode and a discontinuous transmission (DTX) encoding mode based on the information indicating the characteristic of the primary audio signal.

8. The method of claim 1, wherein
the information indicating a characteristic of the primary audio signal comprises information indicating whether or not the primary audio signal is an active signal, or
the information indicating a characteristic of the primary audio signal comprises information indicating whether or not the primary audio signal is a voice signal.

9. The method of claim 1, further comprising encoding the primary audio signal using the selected encoding mode.

10. The method of claim 1, wherein
selecting the encoding mode comprises selecting an encoding parameter, and
encoding the secondary audio signal using the selected encoding mode comprises encoding the secondary audio signal using the selected encoding parameter.

11. An apparatus for selecting an encoding mode for use in encoding one more audio signals, the apparatus comprising:
processing circuitry; and
a memory storing instructions that, when executed by the processing circuitry, causes the apparatus to perform a method comprising:
obtaining a primary audio signal;
obtaining a secondary audio signal;
obtaining information indicating a characteristic of the primary audio signal;
selecting an encoding mode for use in encoding the secondary audio signal based at least in part on the information indicating the characteristic of the primary audio signal; and
encoding the secondary audio signal using the selected encoding mode.

12. The apparatus of claim 11, wherein the method further comprises:
obtaining a first audio signal; and
obtaining a second audio signal, wherein
the primary audio signal is a function of the first and second audio signals, and
the secondary audio signal is a function of the first and second audio signals.

13. The apparatus of claim 12, wherein
obtaining the primary audio signal comprises summing the first and second audio signals, and obtaining the secondary audio signal comprises obtaining a difference between the first and second audio signals, or
obtaining the secondary audio signal comprises summing the first and second audio signals, and obtaining the primary audio signal comprises obtaining a difference between the first and second audio signals.

14. The apparatus of claim 11, wherein
the information indicating a characteristic of the primary audio signal comprises information indicating whether or not the primary audio signal is dominated by a certain audio signal type, or
the information indicating a characteristic of the primary audio signal comprises information indicating whether a certain audio signal type is present.

15. The apparatus of claim 11, wherein the method further comprises:
determining that the information indicating the characteristic of the primary audio signal indicates that the primary signal is an active signal, wherein
selecting an encoding mode for use in encoding the secondary audio signal based at least in part on the information indicating the characteristic of the primary audio signal comprises selecting an active signal encoding mode for encoding the secondary audio signal as a result of determining that the information indicating the characteristic of the primary audio signal indicates that the primary signal is an active signal, and
the step of encoding the secondary audio signal using the selected active signal encoding mode is performed regardless of whether or not the secondary audio signal is also an active signal.

16. The apparatus of claim 11, wherein selecting the encoding mode for use in encoding the secondary audio signal based at least in part on the information indicating the characteristic of the primary audio signal comprises selecting between an active signal encoding mode and a discontinuous transmission (DTX) encoding mode based on the information indicating the characteristic of the primary audio signal.

17. The apparatus of claim 11, wherein
the information indicating a characteristic of the primary audio signal comprises information indicating whether or not the primary audio signal is an active signal, or
the information indicating a characteristic of the primary audio signal comprises information indicating whether or not the primary audio signal is a voice signal.

18. The apparatus of claim 11, wherein the method further comprises encoding the primary audio signal using the selected encoding mode.

19. The apparatus of claim 11, wherein
selecting the encoding mode comprises selecting an encoding parameter, and
encoding the secondary audio signal using the selected encoding mode comprises encoding the secondary audio signal using the selected encoding parameter.

20. A computer program product comprising a non-transitory computer readable medium storing a computer program, the computer program comprising computer program code which, when executed by processing circuitry of an apparatus causes the apparatus to perform a method comprising:
obtaining a primary audio signal;
obtaining a secondary audio signal;
obtaining information indicating a characteristic of the primary audio signal;
selecting an encoding mode for use in encoding the secondary audio signal based at least in part on the information indicating the characteristic of the primary audio signal; and
encoding the secondary audio signal using the selected encoding mode.
